(19) United States
(12) Patent Application Publication
(10) Pub. No.: US 2012/0111835 A1
(43) Pub. Date: May 10, 2012

(54) WET ETCHING APPARATUS AND METHOD

(75) Inventors: Shohichi Ogata, Osaka (JP); Daisuke Suganaga, Hyogo (JP)

(73) Assignees: SUMITOMO PRECISION PRODUCTS CO., LTD., Amagasaki-shi, Hyogo (JP); SHARP KABUSHIKI KAISHA, Osaka-shi, Osaka (JP)

(21) Appl. No.: 13/386,379

(22) PCT Filed: Jul. 14, 2010
(86) PCT No.: PCT/JP2010/061889

§ 371 Date: Jan. 20, 2012

(30) Foreign Application Priority Data
Jul. 23, 2009 (JP) 2009-172456

(51) Int. Cl. B44C 1/22

(52) U.S. Cl. 216/83; 156/345.18

(57) ABSTRACT

A wet etching apparatus includes: an etching vessel applying etchant to a substrate to etch the substrate; and a water cleaning vessel and a drying vessel connected to the etching vessel, successively processing the substrate, and provided with an air knife removing droplets on the substrate. The wet etching apparatus further includes: a duct connected at least to the etching vessel and having an interior maintained at a negative pressure; and an exhaust pipe connecting the water cleaning vessel and the drying vessel to the duct. The exhaust pipe is provided with an auto damper opening/closing the exhaust pipe and an inlet introducing external air. This allows the air knife to operate while allowing the wet etching apparatus to hold internal pressure lower than external pressure.

### TECHNICAL FIELD

The present invention relates to wet etching apparatuses and methods, and particularly to wet etching apparatuses provided with an air knife and wet etching methods using an air knife.

### BACKGROUND ART

A step in fabricating a liquid crystal display to provide a desired thin film on a thin film transistor (TFT) substrate involves wet etching. FIG. 4 is a schematic diagram showing a configuration of a conventional wet etching apparatus. As shown in FIG. 4, a wet etching apparatus 40 is configured of a plurality of processing vessels.

Wet etching apparatus 40 has a loader vessel 2, an atmospheric plasma vessel 3, a liquid prevention vessel 4, an etching vessel 5, a water cleaning vessel 6, a drying vessel 7, and an unloader vessel 8 successively connected thereto. A substrate 10, having undergone a previous step and accommodated in a transportation container such as a cassette, is loaded into loader vessel 2. Substrate 10 loaded into loader vessel 2 is ejected from the cassette and placed on an upper surface of a substrate transportation roller 11.

Substrate transportation rollers 11 are connected from loader vessel 2 to unloader vessel 8. A revolving window or the like (not shown) is provided between the vessels that configure wet etching apparatus 40, and normally the vessels are closed spaces. When substrate 10 moves between the vessels, the window revolves to allow substrate 10 to pass therethrough.

Atmospheric plasma vessel 3 subjects foreign matters adhering on substrate 10 to an atmospheric plasma cleaning step to clean an upper surface of substrate 10. Liquid prevention vessel 4 is provided to prevent etchant used in etching vessel 5 from flowing into atmospheric plasma vessel 3.

In etching vessel 5, an etchant spray 12 sprays etchant to an upper surface of substrate 10. The etchant removes a thin film that is not covered with resist, and thus patterns a thin film on substrate 10.

Water cleaning vessel 6 has an entrance with an air knife 14 disposed over and under substrate transportation roller 11 for removing droplets of the etchant. Air knife 14 blows high pressure air from a front side to a rear side as seen in a direction in which the substrate is transported, with air knife 14 forming a predetermined angle relative to a major surface of substrate 10. Water cleaning vessel 6 has a center with a pure water spray 13 to spray pure water for cleaning substrate 10. Pure water spray 13 sprays pure water on the upper surface of substrate 10 having the etchant removed by air knife 14.

Drying vessel 7 has an air knife 15 therein over and under substrate transportation roller 11 for drying the pure water sprayed in water cleaning vessel 6. Air knife 15 blows high pressure air to the major surface of substrate 10 to remove droplets of pure water and thus dry substrate 10. Unloader vessel 8 accommodates substrate 10 in a transportation container, such as a cassette, in order to unload substrate 10 for a subsequent step. Substrate 10 accommodated in the cassette is unloaded for the subsequent step.

Wet etching apparatus 40 has atmospheric plasma vessel 3, etching vessel 5, and water cleaning vessel 6 provided with exhaust pipes 18, 16, and 19, respectively, connected to a duct 9 having an interior maintained at a negative pressure. Duct 9 is connected to exhaustion equipment in a factory and is connected to various equipment in the factory. Exhaustion 20 from each equipment passes through duct 9. Thus, wet etching apparatus 40 normally has each vessel with an internal pressure maintained to be lower than the pressure external to the apparatus.

Exhaust pipe 16 connected to etching vessel 5 has an auto damper 17 therein to open/close exhaust pipe 16. Auto damper 17 is controlled to close exhaust pipe 16 when an etching process is performed in etching vessel 5, and auto damper 17 is controlled to open exhaust pipe 16 when the etching process is not performed.

Wet etching apparatus 40 receives a plurality of substrates 10 successively with a predetermined interval therebetween to etch a thin film on substrate 10. Japanese Patent Laying Open No. 2004-148224 (Patent Literature 1) and WO 2003/066486 (Patent Literature 2) are prior art documents disclosing wet etching apparatuses equipped with an air knife.

### CITATION LIST

### Patent Literature

PTL 1: Japanese Patent Laying-Open No. 2004-148224
PTL 2: WO 2003/066486

### SUMMARY OF INVENTION

### Technical Problem

In wet etching apparatus 40 when substrate 10 is loaded to etching vessel 5 exhaust pipe 16 has auto damper 17 closed. In this state when substrate 10 precedingly processed is transported to water cleaning vessel 6 air knife 14 operates. When air knife 14 blows air at a flow rate larger than that of the exhaustion of exhaust pipe 19 water cleaning vessel 6 has an internal pressure increased to be higher than adjacent, etching and drying vessels 5 and 7.

In this case, the air in water cleaning vessel 6 flows into etching vessel 5 and drying vessel 7 through gaps of the windows between the vessels. At the time, etching vessel 5 is not exhausting gas, and the air having flown into etching vessel 5 flows into liquid prevention vessel 4 with the etchant. The air having flown into liquid prevention vessel 4 with the etchant flows into atmospheric plasma vessel 3 and is partially exhausted through exhaust pipe 18 to duct 9. The remainder flows into loader vessel 2 and is finally discharged outside wet etching apparatus 1.

Similarly, when substrate 10 is introduced into etching vessel 5, and substrate 10 precedingly processed is introduced into drying vessel 7, air knife 15 operates. Accordingly, drying vessel 7 has an internal pressure increased to be higher than adjacent, water cleaning and unloader vessels 6 and 8.

In this case, the air in drying vessel 7 flows into water cleaning vessel 6 and unloader vessel 8. The air having flown into water cleaning vessel 6 is partially exhausted through exhaust pipe 19 to duct 9. The remainder flows into etching vessel 5. At the time, etching vessel 5 is not exhausting gas, and the air having flown into etching vessel 5 flows into liquid prevention vessel 4 with the etchant. The air having flown into liquid prevention vessel 4 with the etchant flows into atmospheric plasma vessel 3 and is partially exhausted through exhaust pipe 18 to duct 9. The remainder flows into loader vessel 2 and is finally discharged outside wet etching apparatus 1.

The etching process employs a corrosive etchant, and if the etchant flows out of etching vessel 5, the etchant will corrode other equipment. Furthermore, etchant smells, and when it flows out of wet etching apparatus 40, it affects human body and is thus in the environment for operation.

The present invention has been made in view of the above disadvantage, and it contemplates a wet etching apparatus allowing an air knife to be operated while the wet etching apparatus can hold its internal pressure to be lower than the pressure external thereto, and a wet etching method allowing the wet etching apparatus to do so.

### Solution to Problem

The present invention provides a wet etching apparatus including: an etching vessel applying etchant to a substrate to etch the substrate; and a substrate processing vessel connected to the etching vessel, successively processing the substrate, and provided with an air knife removing droplets on the substrate. The wet etching apparatus further includes: a duct connected at least to the etching vessel and having an interior maintained at a negative pressure; and an exhaust pipe connecting the substrate processing vessel to the duct. The exhaust pipe is provided with an opening/closing unit opening/closing the exhaust pipe and an inlet introducing external air. The inlet is opened/closed by the opening/closing unit.

Thus, a substrate processing vessel provided with an air knife can be connected to a duct via an exhaust pipe, and thus have its interior exhausted. Furthermore, the exhaust pipe provided with an opening/closing unit can provide exhaustion at an adjusted flow rate. Providing exhaustion at a flow rate increased to be larger than that applied to cause the air knife to blow air allows the substrate processing vessel to hold its internal pressure at a negative pressure. This allows the wet etching apparatus to hold its internal pressure to be lower than external pressure. Furthermore, the exhaust pipe is provided with an opening that communicates with outside the wet etching apparatus and is opened/closed at a degree adjusted to allow exhaust gas and external air to be exhausted together at a fixed flow rate and thus allow the duct to have an internal pressure adjusted and thus held at a constant value.

Preferably, the present wet etching apparatus includes a control unit adjusting an operation of the opening/closing unit to adjust pressure in the substrate processing vessel. The opening/closing unit can be operated as adjusted to allow the substrate processing vessel to have an internal pressure having a predetermined value, and the wet etching apparatus can thus have internal pressure adjusted with precision.

Preferably, the present wet etching apparatus can have the control unit to synchronize the operation of the opening/closing unit with that of the air knife. This allows the air knife to blow air at an adjusted flow rate and the exhaust pipe to provide exhaustion at an adjusted flow rate, and thus allows the substrate processing vessel to have internal pressure adjusted to have a predetermined value. The wet etching apparatus can thus have internal pressure adjusted with precision.

The present wet etching apparatus may have the substrate processing vessel adapted to be at least one of a water cleaning vessel cleaning the substrate with water after the substrate is etched, and a drying vessel drying the substrate after the substrate is cleaned with water.

The present invention provides a wet etching method including: a first step of applying etchant to a substrate to etch the substrate; and a second step of removing droplets on the substrate with an air knife. In the present method when the air knife is operated the substrate processing vessel in the second step provides exhaustion at a flow rate larger than that applied to cause the air knife to blow air.

An amount of air larger than that blown by the air knife can be exhausted to reduce/prevent the etchant flowing out.

Preferably, the present wet etching method merges the exhaustion from the substrate processing vessel and externally introduced air together and thus exhausts it at a fixed flow rate. This allows exhaustion to be provided at a flow rate held at a predetermined value while allowing the substrate processing vessel to have internal pressure held at a predetermined value.

The present wet etching method may have the second step adapted to be at least one of the step of cleaning the substrate with water after the substrate is etched, and the step of drying the substrate after the substrate is cleaned with water.

### Advantageous Effects of Invention

The present invention allows a substrate processing vessel with an air knife to be connected to an exhaust pipe connected to a duct having an interior maintained at a negative pressure to allow the vessel to provide exhaustion at a flow rate larger than that applied to cause the air knife to blow air. Furthermore, an opening/closing unit that opens/closes the exhaust pipe allows exhaustion to be provided at an adjusted flow rate to adjust the substrate processing vessel's internal pressure to adjust the wet etching apparatus's internal pressure to be lower than external pressure. Furthermore, the exhaust pipe is provided with an inlet introducing external air and opened/closed at an adjusted degree to allow exhaust gas and external air to be exhausted together at a fixed flow rate to allow the duct to have an internal pressure adjusted and thus held at a constant value.

### BRIEF DESCRIPTION OF DRAWINGS

FIG. 1 is a schematic diagram showing a configuration of a wet etching apparatus according to one embodiment of the present invention.

FIG. 2 is a schematic diagram showing an exhaust pipe closed by an auto damper, and an inlet opened.

FIG. 3 is a schematic diagram showing the exhaust pipe opened by the auto damper, and the inlet substantially closed.

FIG. 4 is a schematic diagram showing a configuration of a conventional wet etching apparatus.

### DESCRIPTION OF EMBODIMENTS

Hereinafter, a wet etching apparatus and method in one embodiment based on the present invention will be described with reference to the drawings.

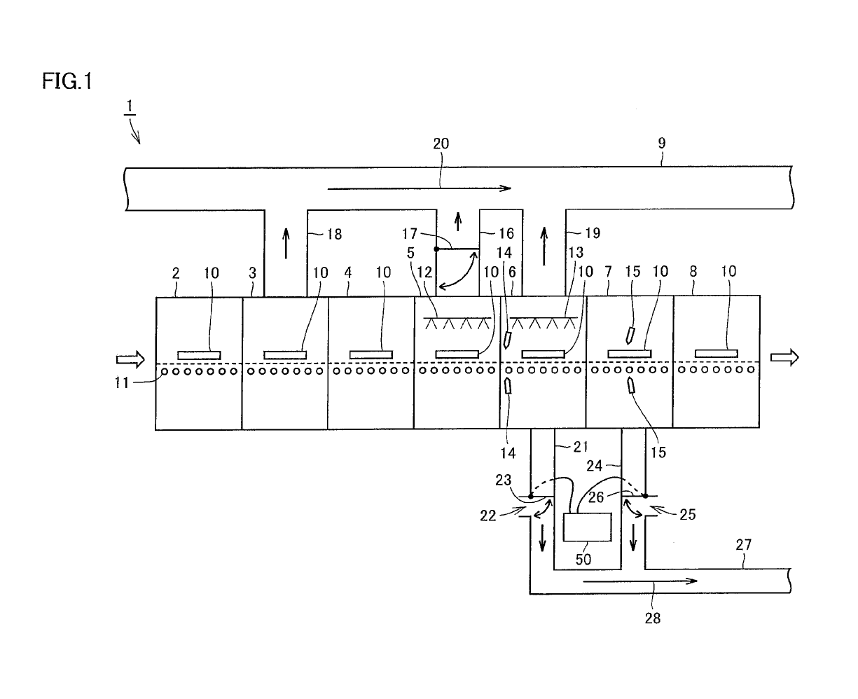

FIG. 1 is a schematic diagram showing a configuration of the wet etching apparatus according to one embodiment of the present invention. As shown in FIG. 1, the present invention in one embodiment provides a wet etching apparatus 1 configured of a plurality of processing vessels.

Wet etching apparatus 1 has a loader vessel 2, an atmospheric plasma vessel 3, a liquid prevention vessel 4, an etching vessel 5, a water cleaning vessel 6, a drying vessel 7, and an unloader vessel 8 successively connected thereto. A substrate 10, having undergone a previous step and accommodated in a transportation container such as a cassette, is loaded into loader vessel 2, ejected from the cassette, and placed on an upper surface of a substrate transportation roller 11.

Substrate transportation rollers 11 are connected from loader vessel 2 to unloader vessel 8. A revolving window or the like (not shown) is provided between the vessels that configure wet etching apparatus 1, and normally the vessels are closed spaces. When substrate 10 moves between the vessels, the window revolves to allow substrate 10 to pass therethrough.

Atmospheric plasma vessel 3 subjects foreign matters adhering on substrate 10 to an atmospheric plasma cleaning step to clean an upper surface of substrate 10. Liquid prevention vessel 4 is provided to prevent the etchant used in etching vessel 5 from flowing into atmospheric plasma vessel 3.

In etching vessel 5, an etchant spray 12 sprays etchant to an upper surface of substrate 10. The etchant removes a thin film that is not covered with resist, and thus patterns a thin film on substrate 10. Note that while the present embodiment employs a spray to apply etchant to substrate 10, the etchant may be applied in any other manner that allows substrate 10 to be etched.

A substrate processing vessel, or water cleaning vessel 6, has an entrance with an air knife 14 over and under substrate transportation roller 11 for removing droplets of the etchant on substrate 10. Air knife 14 blows high pressure air from a front side to a rear side as seen in a direction in which the substrate is transported, with air knife 14 forming a predetermined angle relative to a major surface of substrate 10. Water cleaning vessel 6 has a center, as seen in the direction in which substrate 10 is transported, with a pure water spray 13 disposed to spray pure water for cleaning substrate 10. Pure water spray 13 sprays pure water on the upper surface of substrate 10 having droplets of the etchant removed by air knife 14.

A substrate processing vessel, or drying vessel 7, has an air knife 15 therein over and under substrate transportation roller 11 for drying the pure water sprayed in water cleaning vessel 6. Air knife 15 blows high pressure air to the major surface of substrate 10 to remove droplets of pure water and thus dry substrate 10. Unloader vessel 8 accommodates substrate 10 in a transportation container, such as a cassette, in order to unload substrate 10 for a subsequent step. Substrate 10 accommodated in the cassette is unloaded for the subsequent step.

Wet etching apparatus 1 has atmospheric plasma vessel 3, etching vessel 5, and water cleaning vessel 6 provided with exhaust pipes 18, 16, and 19, respectively, connected to a duct 9 having an interior maintained at a negative pressure. Duct 9 is connected to exhaustion equipment in a factory, and is connected to various equipment in the factory. Exhaustion 20 from each equipment is flowing through duct 9. Thus, wet etching apparatus 1 normally has each vessel with an internal pressure maintained to be lower than the pressure external to the apparatus.

Exhaust pipe 16 connected to etching vessel 5 has an auto damper 17 disposed therein and serving as an opening/closing unit to open/close exhaust pipe 16. Auto damper 17 is controlled to close exhaust pipe 16 when an etching process is performed in etching vessel 5, and auto damper 17 is controlled to open exhaust pipe 16 when the etching process is not performed.

Water cleaning vessel 6 is provided with an exhaust pipe 21. Exhaust pipe 21 is connected to a duct 27 having an interior maintained at a negative pressure. Duct 27 joins duct 9 and is connected to exhaustion equipment in the factory. Exhaust pipe 21 is provided with an inlet 22 introducing external air. Furthermore, exhaust pipe 21 is provided with an auto damper 23 serving as an opening/closing unit to open/close exhaust pipe 21 and inlet 22. While the present embodiment provides exhaust pipe 21 connected to duct 27, exhaust pipe 21 may be connected to duct 9.

Drying vessel 7 is provided with an exhaust pipe 24. Exhaust pipe 24 is connected to duct 27. Exhaust pipe 24 is provided with an inlet 25 introducing external air. Furthermore, exhaust pipe 24 is provided with an auto damper 26 serving as an opening/closing unit to open/close exhaust pipe 24 and inlet 25. While the present embodiment provides exhaust pipe 24 connected to duct 27, exhaust pipe 24 may be connected to duct 9.

Water cleaning vessel 6 and drying vessel 7 are provided with a manometer (not shown) to measure the vessels' internal pressure. This manometer is connected to a control unit 50 which adjusts an operation of auto damper 23 and that of auto damper 26. When air knives 14 and 15 operate and control unit 50 detects that water cleaning vessel 6 and drying vessel 7 have their internal pressures increased, auto dampers 23 and 26 are operated to open exhaust pipes 21 and 24. When exhaust pipes 21 and 24 are opened, water cleaning vessel 6 and drying vessel 7 have their internal air exhausted by the back pressure of duct 27.

Furthermore, when the operations of air knives 14 and 15 are completed and control unit 50 detects that water cleaning vessel 6 and drying vessel 7 have their internal pressures decreased to a predetermined pressure, auto dampers 23 and 26 are operated to close exhaust pipes 21 and 24. Once exhaust pipes 21 and 24 have been closed, water cleaning vessel 6 and drying vessel 7 will no longer have their internal air exhausted. Thus adjusting the operations of auto dampers 23 and 26 allows water cleaning vessel 6 and drying vessel 7 to have internal pressure adjusted to attain a predetermined pressure.

Auto dampers 23 and 26 may be operated, as adjusted by control unit 50, to synchronize with the operation of air knife 14 and that of air knife 15, respectively. This also allows water cleaning vessel 6 and drying vessel 7 to have an adjusted internal pressure.

Exhaust pipes 21 and 24 connect water cleaning vessel 6 and drying vessel 7 to duct 27, and duct 27 joins duct 9. It is preferable that duct 9 and duct 27 have their internal pressures substantially equivalently. Furthermore, it is preferable that duct 27 provide exhaustion 28 at a fixed back pressure.

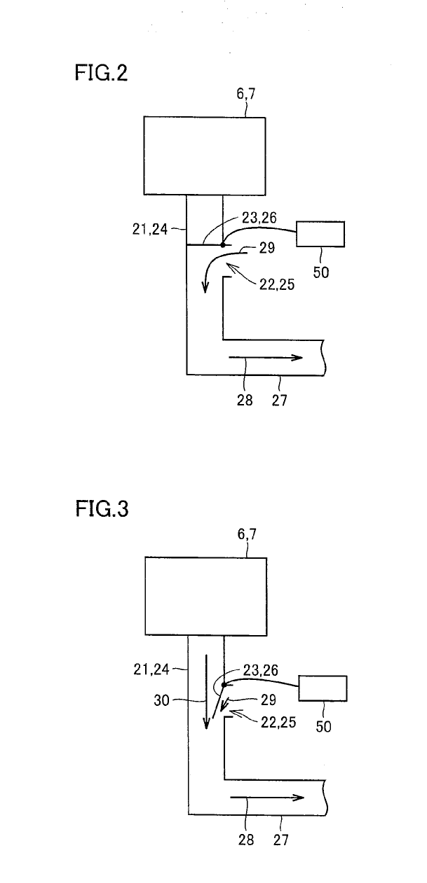

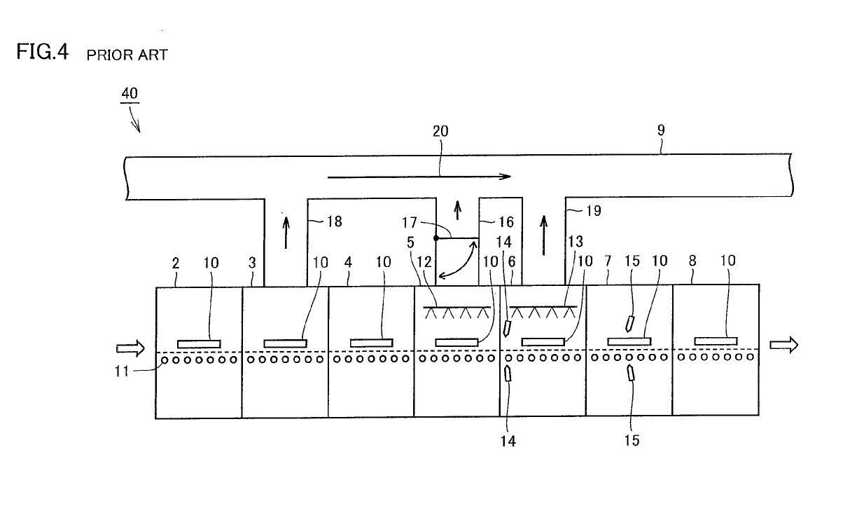

FIG. 2 is a schematic diagram showing an exhaust pipe closed by an auto damper, and an inlet opened. FIG. 3 is a schematic diagram showing the exhaust pipe opened by the auto damper, and the inlet substantially closed.

When water cleaning vessel 6 and drying vessel 7 do not have the air knives in operation, it is unnecessary that exhaust pipes 21 and 24 provide exhaustion. Accordingly, as shown in FIG. 2, auto dampers 23 and 26 close exhaust pipes 21 and 24. At the time, allowing duct 27 to have internal pressure held at a fixed value requires exhaustion 28 to have a flow rate held at a fixed value. Accordingly, inlets 22 and 25 are opened to introduce external air 29 to allow exhaustion 28 to have the flow rate held at the fixed value.

When water cleaning vessel 6 and drying vessel 7 have the air knives in operation, it is necessary that exhaust pipes 21 and 24 provide exhaustion. Accordingly, as shown in FIG. 3, auto dampers 23 and 26 open exhaust pipes 21 and 24. At the time, allowing duct 27 to have internal pressure held at a fixed value requires exhaustion 28 to have a flow rate held at a fixed value. Accordingly, inlets 22 and 25 are substantially closed to reduce the amount external air 29 that is introduced, to allow exhaustion 30 from water cleaning and drying vessels 6 and 7 and external air 29 that are added together, or exhaustion 28, to be held at a fixed flow rate.

As described above, a manometer may be provided to measure the internal pressure of duct 27 in order to keep the back pressure internal to duct 27 at a fixed value. Connecting the manometer to control unit 50 that controls the operations of auto dampers 23 and 26 to adjust auto dampers 23 and 26 to open/close allows duct 27 to have internal, back pressure held at a fixed value.

Duct 27 having its internal, back pressure held at the fixed value allows duct 9, which duct 27 joins, to have less varying internal, back pressure. The less varying back pressure can contribute to a reduced load on exhaustion equipment in a factory.

While in the present embodiment water cleaning vessel 6 and drying vessel 7 are provided with air knives 14 and 15, water cleaning vessel 6 may alone be provided with an air knife for example if the drying step is performed with a heater or the like.

Note that the embodiments disclosed are illustrative in any respect, and do not serve as a basis for limitative interpretation. Therefore, the present invention has a scope demarcated based on the claims, rather than interpreted only via the embodiments disclosed. Furthermore, any variations equivalent in meaning and scope to the claims are encompassed.

### REFERENCE SIGNS LIST

1, 40: wet etching apparatus, 2: loader vessel, 3: atmospheric plasma vessel, 4: liquid prevention vessel, 5: etching vessel, 6: water cleaning vessel, 7: drying vessel, 8: unloader vessel, 9, 27: duct, 10: substrate, 11: substrate transportation roller, 12: etchant spray, 13: pure water spray, 14, 15: air knife, 16, 18, 19: exhaust pipe, 17, 23, 26: auto damper, 20, 28, 30: exhaustion, 21, 24: exhaust pipe, 22, 25: inlet, 29: external air, 50: control unit.

1. A wet etching apparatus comprising:
an etching vessel applying etchant to a substrate to etch said substrate;
a substrate processing vessel connected to said etching vessel, successively processing said substrate, and provided with an air knife removing droplets on said substrate;
a duct connected at least to said etching vessel and having an interior maintained at a negative pressure; and
an exhaust pipe connecting said substrate processing vessel to said duct;
said exhaust pipe being provided with an opening/closing unit opening/closing said exhaust pipe and an inlet introducing external air,
said inlet being opened/closed by said opening/closing unit.

2. The wet etching apparatus according to claim 1, comprising a control unit adjusting an operation of said opening/closing unit to adjust pressure in said substrate processing vessel.

3. The wet etching apparatus according to claim 2, wherein said control unit synchronizes the operation of said opening/closing unit with that of said air knife.

4. The wet etching apparatus according to claim 1, wherein said substrate processing vessel is at least one of a water cleaning vessel cleaning said substrate with water after said substrate is etched, and a drying vessel drying said substrate after said substrate is cleaned with water.

5. A wet etching method comprising:
a first step of applying etchant to a substrate to etch said substrate; and
a second step of removing droplets on said substrate with an air knife,
when said air knife is operated, a substrate processing vessel in said second step providing exhaustion at a flow rate larger than that applied to cause said air knife to blow air.

6. The wet etching method according to claim 5, wherein said exhaustion from said substrate processing vessel and externally introduced air are merged together and thus exhausted at a fixed flow rate.

7. The wet etching method according to claim 5, wherein said second step is at least one of the step of cleaning said substrate with water after said substrate is etched, and the step of drying said substrate after said substrate is cleaned with water.

8. The wet etching apparatus according to claim 2, wherein said substrate processing vessel is at least one of a water cleaning vessel cleaning said substrate with water after said substrate is etched, and a drying vessel drying said substrate after said substrate is cleaned with water.

9. The wet etching apparatus according to claim 3, wherein said substrate processing vessel is at least one of a water cleaning vessel cleaning said substrate with water after said substrate is etched, and a drying vessel drying said substrate after said substrate is cleaned with water.

10. The wet etching method according to claim 6, wherein said second step is at least one of the step of cleaning said substrate with water after the said substrate is etched, and the step of drying said substrate after said substrate is cleaned with water,
